(19) United States
(12) Patent Application Publication
(10) Pub. No.: US 2026/0116704 A1
(43) Pub. Date: Apr. 30, 2026

(54) ELEVATOR SYSTEM WITH STORAGE FOR MOBILE WORKING PLATFORM

(71) Applicant: Otis Elevator Company, Farmington, CT (US)

(72) Inventors: Romain Durand, Gien (FR); Frédéric Beauchaud, Gien (FR)

(21) Appl. No.: 19/365,948

(22) Filed: Oct. 22, 2025

(30) Foreign Application Priority Data
Oct. 25, 2024 (EP) 24306801.2

(51) Int. Cl. B66B 5/00; B66B 11/00; B66B 13/30; E06C 1/39

(52) U.S. Cl. CPC B66B 5/0087; B66B 11/001; B66B 13/303; E06C 1/39

(57) ABSTRACT

An elevator system (1) including a hoistway (2) extending in a longitudinal direction between a plurality of landings (8); and an elevator car (4) defining an interior space (10) and moveable within the hoistway (2). The elevator car (4) forms an opening (22), through which maintenance can be performed above the elevator car (4) from the interior space (10). The elevator system (1) further includes a storage arranged outside the elevator car (4) and configured to store a mobile working platform (36), which is to be positioned in the interior space (10) for reaching through the opening (22) when performing maintenance.

### FOREIGN PRIORITY

This application claims priority to European Patent Application No. 24306801.2, filed Oct. 25, 2024, and all the benefits accruing therefrom under 35 U.S.C. § 119, the contents of which in its entirety are herein incorporated by reference.

### TECHNICAL FIELD

The present disclosure relates to an elevator system having a storage for a mobile working platform that is usable for performing maintenance above an elevator car of the elevator system from an interior space of the elevator car.

### BACKGROUND

It is known that maintenance of an elevator car of an elevator system can be performed through an opening formed at a top end of the elevator car. In order to reach components above the elevator car an integrated working platform, which can be lowered into an interior space of the elevator car by using a support structure, can be integrated into a top frame of an elevator car frame of the elevator car.

In this respect, it is an object of the present disclose to provide an improved technique that enables maintenance above an elevator car from an interior space of the elevator car.

### SUMMARY

According to an aspect an elevator system comprises a hoistway extending in a longitudinal direction between a plurality of landings; and an elevator car defining an interior space and moveable within the hoistway. The elevator car forms an opening, through which maintenance can be performed above the elevator car from the interior space. The opening is formed at a top end of the elevator car. The opening can be defined by an elevator car frame of the elevator car. During normal operation the opening can be covered by a ceiling, for example a decorative ceiling. The elevator system further comprises a storage arranged outside the elevator car and configured to store a mobile working platform, which is to be positioned in the interior space for reaching through the opening when performing maintenance. That is, the mobile working plaform can be moved into the interior space in order to reach through the opening defined at the top end of the elevator car. By using the mobile working platform there is no need to integrate a working platform, which is limited to the size of the elevator car, into the elevator car, for example into the elevator car frame. By omitting the integrated working platform a height of the interior space is not limited. Further, a weight of the elevator car is reduced, which in turn increases an energy efficiency of the elevator system.

According to a further aspect the storage can be configured to store the mobile working platform in a folded state. In this way, a space required for the storage can be reduced.

According to another aspect the storage can be positioned at a top landing close to an electrical and instrumentation (E&I) panel of the elevator system. In this way, the elevator system can be put into maintenance mode in the E&I panel and maintenance of the elevator car can be performed in close proximity to the location where the elevator car is put in maintenance mode.

According to an aspect the storage can be formed in a panel of a landing door. The panel can comprise a door that is hingedly mounted to the panel in order to access the storage inside the panel. In this way, the mobile working platform can be stored without causing visual intrusion.

According to an additional aspect the storage can be formed in a landing control panel. For this reason, the landing control panel needs to be formed with additional space for storing the mobile working platform. In this way, the storage can be integrated into the elevator system without causing visual intrusion.

According to an aspect the storage can be formed in the E&I panel. For this reason, the E&I panel needs to be formed with additional space for storing the mobile working platform. When storing the mobile working platform in the E&I panel, the working platform is stored in close proximity to the location where the elevator car is put into maintenance mode. In addition, a visual intrusion of the storage can be avoided.

According to another aspect the storage can be formed in a machine room of the elevator system. The machine room can include additional space for storing the mobile working platform. In this way, the storage does not intrude the visual appearance of the elevator system.

According to a further aspect the storage can be formed by a cabinet arranged at one of the landings close to a respective landing door. The cabinet can be shaped in accordance with the mobile working platform. By arranging the cabinet close to the respective landing door, the mobile working platform can be inserted into the elevator car easily.

According to an aspect the cabinet can be separate from a wall defining the hoistway. In this way, the cabinet, i.e. the storage, can be retrofitted easily.

According to another aspect the cabinet can be integrated in a wall defining the hoistway so as to be flush with the wall. The space for the cabinet is to be considered when constructing the wall. In this way, a visual intrusion of the storage can be reduced.

According to a further aspect the elevator car cannot comprise an integrated working platform. In this way, a height of the elevator car is not limited by the integrated working platform. Further, a weight of the elevator car can be reduced so that an energy efficiency of the elevator system is increased.

### BRIEF DESCRIPTION OF THE DRAWINGS

Embodiments of the present disclosure, as an example only, will be described in the following with reference to the drawings. In the drawings:

FIG. 1 schematically illustrates an elevator system;

FIG. 2 schematically illustrates an elevator car of the elevator system;

FIGS. 3A to 3D schematically illustrate examples of mobile working platforms;

FIG. 4 schematically illustrates a perspective view of a landing with a cabinet for storing a mobile working platform; and

FIG. 5 schematically illustrates a perspective view of the landing with the cabinet storing a folded working platform shown in FIG. 2B.

### DETAILED DESCRIPTION OF THE INVENTION

In the following, embodiments of the present disclosure are explained with reference to the drawings. The same elements are assigned the same reference numbers in the drawings. It is to be noted, that the embodiments are described for exemplary purposes only and the description of the embodiments is not intended to limit the scope of the present disclosure.

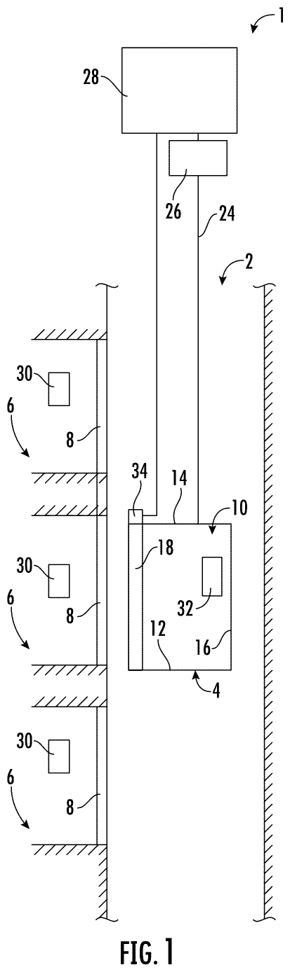

FIG. 1 schematically illustrates an elevator system 1 comprising a hoistway 2 and an elevator car 4. The hoistway 2 extends in a longitudinal direction between a plurality of landings 6 located on different floors of a building. Each landing 6 is provided with a landing door (can also referred to as an elevator hoistway door) 8.

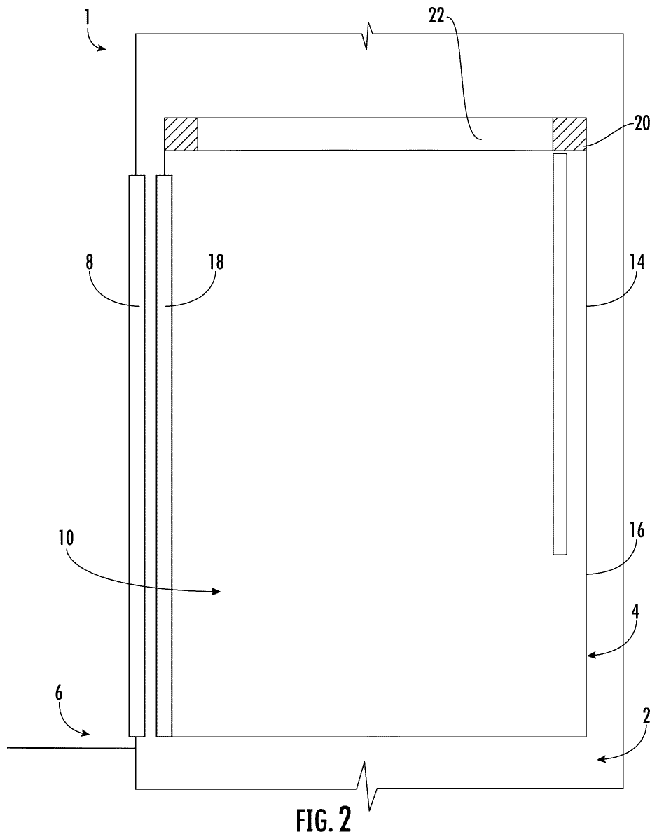

As shown in FIGS. 1 and 2, the elevator car 1 defines an interior space 10 in the shape of a cuboid for accommodating passengers and/or cargo. For this purpose, the elevator car 4 comprises a floor 12, a ceiling 14 and sidewalls 16 extending between the floor 12 and the ceiling 14. Only one sidewall 16 is depicted in the schematic illustration of FIG. 1. In some embodiments, the elevator car 4 can have the shape of an oval or round cylinder and the floor, the ceiling and the sidewalls can be formed accordingly.

At least one of the sidewalls 16 includes an elevator door 18, which is provided in correspondence with the landing door 8 so as to allow passengers to transfer between one of the landings 6 and the interior space 10 of the elevator car 4 when the elevator car 4 is positioned at a respective landing 8.

As shown in FIG. 2, the elevator car 4 can have an elevator car frame 20. It is to be noted that in FIG. 2 only a top frame of the elevator car frame 6 is shown. In some embodiments, the elevator car 1 can only have the top frame. The top frame of the elevator car frame 20 defines an opening 22, through which maintenance can be performed above the elevator car 4.

As shown in FIG. 2, the ceiling 14 can be removably attached above the interior space 10. For this reason, one edge of the ceiling 14 can be hingedly mounted to the elevator car frame 20 so that it is pivotable with respect to the opening 22. FIG. 2 shows a situation, in which the ceiling 14 is removed to expose the opening 22.

As shown in FIG. 1, the elevator car 4 is movably suspended within the hoistway 2 by means of a tension member 24. The tension member 24, for example a rope or belt, is connected to a drive 26, which is configured for driving the tension member 24 in order to move the elevator car 4 along the longitudinal direction of the hoistway 2 between the plurality of landings 6.

The exemplary embodiment of the elevator system 1 shown in FIG. 1 employs a 1:1 roping for suspending the elevator car 4. The skilled person, however, easily understands that the type of the roping is not essential for the disclosure and that different kinds of roping, e.g. a 2:1 roping, may be used as well.

The elevator system 1 may further include a counterweight (not shown) moving concurrently and in opposite direction with respect to the elevator car 4. Alternatively, the elevator system 1 may be an elevator system 1 without a counterweight, as it is shown in FIG. 1. The drive 26 may be any form of drive used in the art, e.g. a traction drive, a hydraulic drive or a linear drive. The elevator system 1 may have a machine room or may be a machine roomless elevator system. The elevator system 1 may use a tension member 24, as it is shown in FIG. 1, or it may be an elevator system without a tension member 24, comprising e.g. a hydraulic drive or a linear drive (not shown).

The drive 26 is controlled by an elevator control (not shown) for moving the elevator car 6 along the hoistway 4 between the different landings 8. The elevator control can be arranged inside an electrical and instrumentation (E&I) panel 28, which is normally positioned at a top landing 6 of the elevator system 1 or in a machine room (if any) of the elevator system 1.

Input to the elevator control may be provided via landing control panels 30, which are provided on each landing 6 close to the landing door 8, and/or via a car control panel 32 provided inside the elevator car 4. The car control panel 32 can be integrated into one of the sidewalls 16.

The landing control panels 30 and the car control panel 32 may be connected to the elevator control by means of electrical lines, which are not shown in FIG. 1, in particular by an electric bus, e.g. a field bus such as a CAN bus, or by means of wireless data connections.

In order to determine the current position of the elevator car 4, the elevator car 4 can be provided with a position sensor 34. The position sensor 34 may be arranged at the top of the elevator car 4, as shown in FIG. 1. Alternatively, the position sensor 34 may be provided at a side of the elevator car 4 or at the bottom, e.g. below the floor 12, of the elevator car 4.

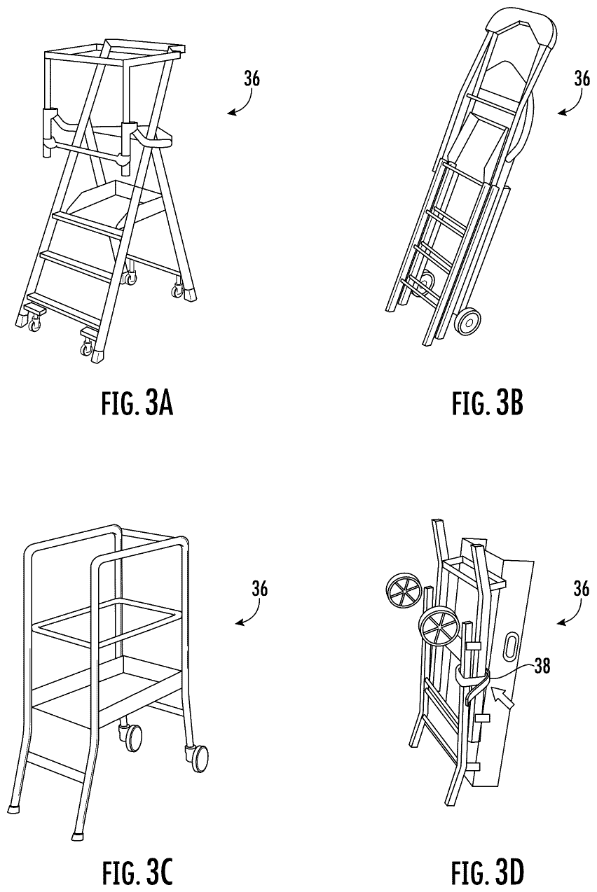

In order to perform maintenance above the elevator car 4 from inside the interior space 10, a maintenance person removes the ceiling 14 and positions a mobile working platform 36 into the interior space 10. According to some embodiments, the working platform 36 may be foldable. Examples of different mobile working platforms 36 are shown in FIGS. 3A to 3D. FIG. 3A shows a mobile working platform 36 in an unfolded state. FIG. 3B shows the working platform 36 of FIG. 3A in a folded sate. FIG. 3C shows another working platform 36 in an unfolded state. FIG. 3D shows a different working platform 36 in a folded state. In some embodiments, the mobile working platform can be secured in the folded state by using a fixing member, like a belt 38, as shown in FIG. 3D.

During a normal operation of the elevator system 1, the mobile working platform 36 is stored in a storage outside the elevator car 4. According to some embodiments, the mobile working 36 platform can be stored in the folded state. Moreover, the storage can be positioned at a top landing 6 in close proximity to the E&I panel 28.

As one example, the storage for storing the mobile working platform 36 can be formed by a panel of one of the landing doors 8. The landing door can comprise a door, which is hingedly mounted to the landing door in order to access the storage. In some embodiments, the mobile working platform 36 can be stored in a panel of the landing door 8 at the top landing 6.

As another example, the storage for storing the mobile working platform 36 can be formed in the E&I panel 28. As mentioned above, the E&I panel 28 can be located at the top landing 6 of the elevator system 1.

As a further example, the storage for storing the mobile working platform 36 can be formed in a landing control panel 30. In some embodiments, the mobile working platform 36 can be stored in the landing control panel 30 at the top landing 6.

As an additional example, the storage for storing the mobile working platform 36 can be formed in the machine room of the elevator system.

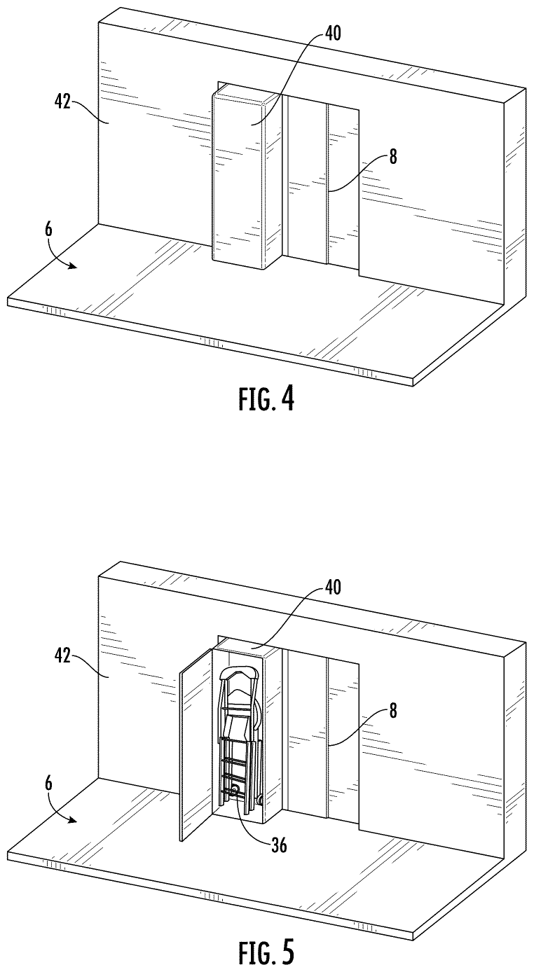

Further, as shown in FIGS. 4 and 5, a cabinet 38 can be provided as the storage for storing the mobile working platform 36. As shown in FIG. 5, the cabinet 38 can be configured to store the mobile working platform 36 in a folded state. In the examples shown in FIGS. 4 and 5, the cabinet 40 protrudes from a wall 42 defining the hoistway 2. In some embodiments, the cabinet 40 can be integrated in the wall 42 so as to be flush with the wall 42.

It is to be noted that multiple examples of the storage for storing a mobile working platform 36 have been described. The elevator system 4 according to the present disclosure can comprise multiple storages according to the above-described different examples.

What is claimed is:

1. An elevator system (1) comprising:
a hoistway (2) extending in a longitudinal direction between a plurality of landings (8); and
an elevator car (4) defining an interior space (10) and moveable within the hoistway (2), wherein the elevator car (4) forms an opening (22), through which maintenance can be performed above the elevator car (4) from the interior space (10);
characterized in that
the elevator system (1) further comprises a storage arranged outside the elevator car (4) and configured to store a mobile working platform (36), which is to be positioned in the interior space (10) for reaching through the opening (22) when performing maintenance.

2. The elevator system (1) according to claim 1, wherein
the storage is configured to store the mobile working platform (36) in a folded state.

3. The elevator system (1) according to claim 1, wherein
the storage is positioned at a top landing (6) close to an electrical and instrumentation (E&I) panel (28) of the elevator system (1).

4. The elevator system (1) according to claim 1, wherein
the storage is formed in a panel of a landing door (8).

5. The elevator system (1) according to claim 1, wherein
the storage is formed in a landing control panel (30).

6. The elevator system (1) according to claim 1, wherein
the storage is formed in the E&I panel (28).

7. The elevator system (1) according to claim 1, wherein
the storage is formed in a machine room of the elevator system (1).

8. The elevator system (1) according to claim 1, wherein
the storage is formed by a cabinet (40) arranged at one of the landings (6) close to a respective landing door (8).

9. The elevator system (1) according to claim 8, wherein
the cabinet (40) is separate from a wall (42) defining the hoistway (2).

10. The elevator system (1) according to claim 8, wherein
the cabinet (40) is integrated in a wall (42) defining the hoistway (2) so as to be flush with the wall (42).

11. The elevator system (1) according to claim 1, wherein
the elevator car (4) does not comprise an integrated working platform.
